(19) United States
(12) Patent Application Publication
(10) Pub. No.: US 2022/0277467 A1
(43) Pub. Date: Sep. 1, 2022

(54) TOF-BASED DEPTH MEASURING DEVICE AND METHOD AND ELECTRONIC EQUIPMENT

(71) Applicant: ORBBEC INC., Shenzhen (CN)

(72) Inventors: Peng YANG, SHENZHEN (CN); Zhaomin WANG, SHENZHEN (CN)

(21) Appl. No.: 17/748,406

(22) Filed: May 19, 2022

Related U.S. Application Data
(63) Continuation of application No. PCT/CN2020/141868, filed on Dec. 30, 2020.

(30) Foreign Application Priority Data
May 24, 2020 (CN) 202010445256.9

(51) Int. Cl. G06T 7/521; H04N 5/225; G06T 7/55; G01S 17/36; G01S 17/894

(52) U.S. Cl. CPC G06T 7/521; H04N 5/2256; G06T 7/55; G01S 17/36; G01S 17/894; G06T 2207/20081; G06T 2207/20084; G06T 2207/10028

(57) ABSTRACT

A time of flight (TOF)-based depth measuring device is provided, which includes: a light emitter, configured to emit a beam to a target object; a light sensor, configured to capture a reflected beam reflected by the target object, generate a corresponding electrical signal, and obtain a two-dimensional image of the target object; and a processor, connected to the light emitter and the light sensor, and configured to: control the light emitter to emit a modulated beam, turn on the imaging module to receive the electrical signal and the two-dimensional image, perform calculation on the electrical signal to obtain one or more TOF depth values of the target object, perform deep learning by using the two-dimensional image to obtain a relative depth value, and determine an actual depth value from the one or more TOF depth values based on the relative depth value.

### CROSS-REFERENCE TO RELATED APPLICATIONS

This is a continuation of International Patent Application No. PCT/CN2020/141868, filed with the China National Intellectual Property Administration (CNIPA) on Dec. 30, 2020, which is based on and claims priority to and benefits of Chinese Patent Application No. 202010445256.9, filed on May 24, 2020, and entitled “TOF-BASED DEPTH MEASURING DEVICE AND METHOD AND ELECTRONIC EQUIPMENT.” The content of all of above-identified applications is incorporated herein by reference in its entirety.

### TECHNICAL FIELD

This application relates to the field of optical measurement technologies, and in particular, to a time of flight (TOF)-based depth measuring device and method and electronic equipment.

### BACKGROUND

TOF is short for time of flight. TOF ranging technique is to realize accurate ranging by measuring a round-trip time of a light pulse between an emitting/receiving device and a target object. Among TOF techniques, the measurement technique that periodically modulates an emitted optical signal, measures a phase delay of a reflected optical signal relative to a reflected optical signal, and calculates a time of flight based on the phase delay is referred to as an indirect TOF (iTOF) technique. The iTOF technique can be divided into a continuous wave (CW) modulation and demodulation method and a pulse-modulated (PM) modulation and demodulation method according to different modulation and demodulation types and manners.

It is to be understood that, in a measurement solution of a phase-based iTOF technique, a phase of a return beam can be used to calculate an accurate measurement within “wrapping” on a given phase (that is, a wavelength). However, once an actual distance exceeds a maximum measurement distance of a measurement device, a large error occurs during the measurement period, resulting in a significant impact on the accuracy of measurement data.

### SUMMARY

This application provides a TOF-based depth measuring device and method and electronic equipment to resolve at least one of the foregoing problems in the existing techniques.

Embodiments of this application provide a TOF-based depth measuring device, including: a light emitter configured to emit a beam to a target object; a light sensor configured to capture a reflected beam reflected by the target object, generate an electrical signal corresponding to the reflected beam, and obtain a two-dimensional image of the target object; and a processor connected to the light emitter and the light sensor, and configured to: control the light emitter to emit a modulated beam to a target space, turn on the light sensor to receive the electrical signal generated by the light sensor and the two-dimensional image, perform calculation on the electrical signal to obtain one or more TOF depth values of the target object, obtain a relative depth value of the target object according to the two-dimensional image, and determine an actual depth value from the one or more TOF depth values based on the relative depth value.

In some embodiments, the light emitter is configured to emit, under the control of the processor and at one or more modulation frequencies, the modulated beam of which an amplitude is modulated by a continuous wave; the light sensor is configured to capture at least a part of the reflected beam and generate the electrical signal; and the processor is configured to calculate a phase difference based on the electrical signal, calculate a time of flight from the beam being emitted at the light emitter to the reflected beam being captured by the light sensor based on the phase difference, and calculate the one or more TOF depth values based on the time of flight.

In some embodiments, the processor further comprises a convolutional neural network structure configured to perform deep learning on the two-dimensional image to obtain the relative depth value of the target object.

The embodiments of this application further provide a TOF-based depth measuring method, including the following steps: emitting, by a light emitter, a beam to a target object; capturing, by a light sensor, a reflected beam reflected by the target object, generate an electrical signal based on the reflected beam, and obtain a two-dimensional image of the target object; and receiving, by a processor, the electrical signal generated by the light sensor and the two-dimensional image from the light sensor, performing calculation on the electrical signal to obtain one or more TOF depth values of the target object, obtaining a relative depth value of the target object according to the two-dimensional image, and determining an actual depth value from the one or more TOF depth values based on the obtained relative depth value.

In some embodiments, the method further comprising: emitting, by the light emitter, under the control of the processor and at one or more modulation frequencies, a modulated beam of which an amplitude is modulated by a continuous wave; capturing, by the light sensor, at least a part of the reflected beam reflected by the target object, and generating the electrical signal; and calculating, by the processor, a phase difference based on the electrical signal, calculating a time of flight from the beam being emitted at the light emitter to the reflected beam being captured by the light sensor based on the phase difference, and calculating the one or more TOF depth values based on the time of flight.

In some embodiments, the processor comprises a convolutional neural network structure configured to perform deep learning on the two-dimensional image to obtain the relative depth value of the target object.

In some embodiments, the method further comprising: obtaining, by the processor, differences between the one or more TOF depth values and the relative depth value, obtaining absolute values of the differences, and selecting a TOF depth value corresponding to a least absolute value as the actual depth value; or unwrapping, by the processor, the one or more TOF depth values based on continuity of the relative depth value, and determining the actual depth value from the one or more TOF depth values.

In some embodiments, the method further comprising: generating, by the processor, a TOF depth map of the target object based on the one or more TOF depth values, and generating a relative depth map of the target object based on relative depth values.

In some embodiments, the method further comprising: generating a depth map of the target object based on the actual depth value; or integrating the TOF depth map with the relative depth map to generate a depth map of the target object.

The embodiments of this application further provide an electronic equipment, including a housing, a screen, and a TOF-based depth measuring device. The TOF-based depth measuring device comprises a processor, a light emitter, and a light sensor, and the light emitter and the light sensor are disposed on a same side of the electronic equipment; the light emitter, configured to emit a beam to a target object; the light sensor, configured to capture a reflected beam reflected by the target object, generate an electrical signal corresponding to the reflected beam, and obtain a two-dimensional image of the target object; and the processor connected to the light emitter and the light sensor, and configured to: control the light emitter to emit a modulated beam to a target space, turn on the light sensor to receive the electrical signal generated by the light sensor and the two-dimensional image, perform calculation on the electrical signal to obtain one or more TOF depth values of the target object, obtain a relative depth value of the target object according to the two-dimensional image, and determine an actual depth value from the one or more TOF depth values based on the relative depth value.

In an embodiment, turning on the light sensor is synchronized with the emitting the modulated beam to the target space.

In an embodiment, the deep learning is performed on the two-dimensional image to obtain the relative depth value of the target object simultaneously while performing the calculation on the electrical signal.

In an embodiment, the light sensor is a first light sensor and the two-dimensional image of the target object is a first two-dimensional image of the target object, wherein the device further comprises a second light sensor configured to obtain a second two-dimensional image of the target object.

In an embodiment, the relative depth value of the target object is obtained according to the first two-dimensional image and the second two-dimensional image.

The embodiments of this application provide a TOF-based depth measuring device as described above. By performing deep learning on the two-dimensional image to obtain the relative depth value, and unwrapping TOF depth values based on the relative depth value, precision, integrity, and a frame rate of a depth map is improved without increasing the costs of an existing depth measuring device.

### BRIEF DESCRIPTION OF THE DRAWINGS

To describe the technical solutions in the embodiments of this application or existing technologies more clearly, the following briefly describes the accompanying drawings required for describing the embodiments of this application or the existing technologies. Apparently, the accompanying drawings in the following description show only some embodiments of this application, and a person of ordinary skill in the art may derive other drawings from the accompanying drawings without creative efforts.

FIG. 1 is a principle diagram of a TOF-based depth measuring device, according to an embodiment of this application.

FIG. 2 is a flowchart of a TOF-based depth measuring method, according to an embodiment of this application.

FIG. 3 is a schematic diagram of electronic equipment adapting the measuring device as shown in FIG. 1, according to an embodiment of this application.

### DETAILED DESCRIPTION

To make the to-be-resolved technical problems, the technical solutions, and the advantageous effects of the embodiments of this application clearer and more comprehensible, the following further describes this application in detail with reference to the accompanying drawings and embodiments. The specific embodiments described herein are merely used to explain this application but do not limit this application.

It is to be noted that, when an element is described as being “fixed on” or “disposed on” another element, the element may be directly located on the another element, or indirectly located on the another element. When an element is described as being “connected to” another element, the element may be directly connected to the another element, or indirectly connected to the another element. In addition, the connection may be used for fixation or circuit connection.

It should be understood that orientation or position relationships indicated by the terms such as “length,” “width,” “above,” “below,” “front,” “back,” “left,” “right,” “vertical,” “horizontal” “top,” “bottom,” “inside,” and “outside” are based on orientation or position relationships shown in the accompanying drawings, and are used only for ease and brevity of illustration and description of the embodiments of this application, rather than indicating or implying that the mentioned device or component needs to have a particular orientation or needs to be constructed and operated in a particular orientation. Therefore, such terms should not be construed as limiting this application.

In addition, terms “first” and “second” are used merely for the purpose of description, and shall not be construed as indicating or implying relative importance or implying a quantity of indicated technical features. In view of this, a feature defined by “first” or “second” may explicitly or implicitly include one or more features. In the description of the embodiments of this application, unless otherwise specifically limited, “a plurality of” means two or more than two.

For ease of understanding, a TOF-based depth measuring device is first described. The TOF-based depth measuring device includes a light emitter (e.g., a light emitting module), a light sensor (e.g., an imaging module), and a processor (e.g., a control and processing device). The light emitting module emits a beam to a target space. The beam is emitted to the target space for illuminating a target object in the space. At least a part of the emitted beam is reflected by a target object to form a reflected beam, and at least a part of the reflected beam is received by the imaging module. The control and processing device is connected to the light emitting module and the imaging module, and synchronizes trigger signals of the light emitting module and the imaging module to calculate a time from the beam being emitted to the reflected beam being received, that is, a time of flight t between an emitted beam and a reflected beam. Further, based on the time of flight t, a distance D to corresponding point on the target object can be calculated based on the following formula:

D=c·t/2 (1),

where c is a speed of light.

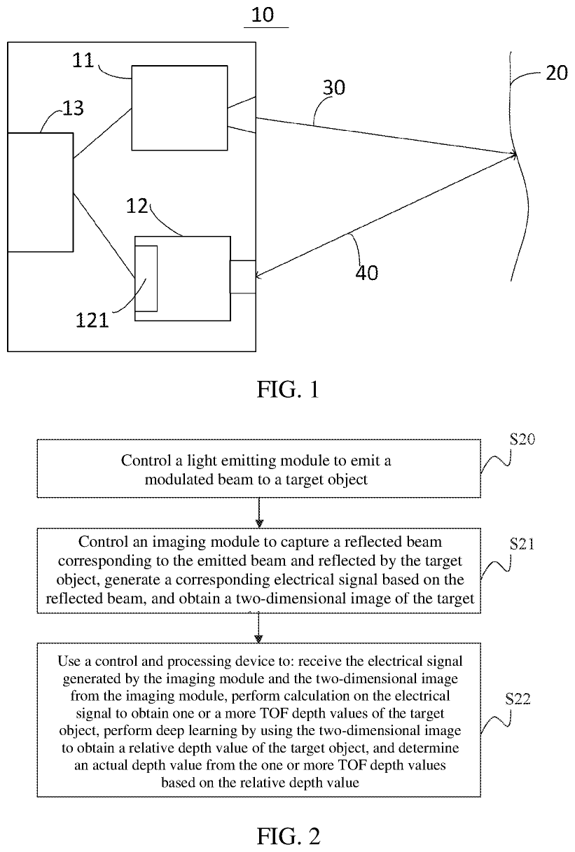

For example, FIG. 1 is a principle diagram of a TOF-based depth measuring device, according to an embodiment of this application. The TOF-based depth measuring device 10 includes a light emitting module 11, an imaging module 12, and a control and processing device 13. The light emitting module 11 is configured to emit a beam 30 to a target object. The imaging module 12 is configured to capture a reflected beam 40 reflected by the target object, generate a corresponding electrical signal, and obtain a two-dimensional image of the target object. The control and processing device 13 is connected to the light emitting module 11 and the imaging module 12, and configured to: control the light emitting module 11 to emit a modulated beam to a target space 20 to illuminate the target object in the space, synchronously trigger the imaging module 12 to be turned on and receive the electrical signal generated by the imaging module 12 and the two-dimensional image, perform calculation on the electrical signal to obtain one or more TOF depth values of the target object, simultaneously perform deep learning by using the two-dimensional image to obtain a relative depth value of the target object, and then determine an actual depth value from the one or more obtained TOF depth values based on the relative depth value.

In some embodiments, the light emitting module 11 includes a light source, a light source drive (not illustrated in the figure), and the like. The light source may be a dot-matrix light source or a planar-array light source. The dot-matrix light source may be a combination of a lattice laser and a liquid-crystal switch/diffuser/diffractive optical element. The lattice laser may be a light-emitting diode (LED), an edge-emitting laser (EEL), a vertical cavity surface emitting laser (VCSEL), and the like. The combination of a lattice laser and a liquid-crystal switch/diffuser may be equivalent to a planar-array light source, which can output uniformly distributed planar-array beams, to facilitate subsequent integration of charges.

The function of the liquid-crystal switch is to make a beam emitted by the light source irradiate the entire target space more uniformly. The function of the diffuser is to shape a beam emitted by the lattice laser into a planar-surface beam. A beam emitted by the combination of a lattice laser and a diffractive optical element is still laser speckles, and the diffractive optical element increases density of the emitted laser speckles to achieve relatively concentrated energy and relatively strong energy per unit area, thereby providing a longer acting/operating distance. The planar-array light source may be a light source array including a plurality of lattice lasers or may be a floodlight source, for example, an infrared floodlight source, which can also output uniformly distributed planar-array beams, to facilitate the subsequent integration of charges.

The beam emitted by the light source may include visible light, infrared light, ultraviolet light, or the like. Considering the ambient light, the safety of laser, and other factors, infrared light is mainly used. Under the control of the light source drive, the light source emits outwards a beam of which an amplitude is temporally modulated. For example, in some embodiments, under the driving of the light source drive, the light source emits a pulse modulated beam, a square-wave modulated beam, a sine-wave modulated beam, and other beams at a modulation frequency f. In some embodiments, the light emitting module further includes a collimating lens disposed above the light source and configured to collimate the beams emitted by the light source. The light source drive may further be controlled by the control and processing device, or may be integrated into the control and processing device.

The imaging module 12 includes a TOF image sensor 121 and a lens unit (not illustrated). In some embodiments, the imaging module may also include a light filter (not illustrated in the figure). The lens unit may be a condensing lens, and may be configured to focus and image at least a part of the reflected beam reflected by the target object onto at least a part of the TOF image sensor. The light filter may be a narrow band light filter matching with a light source wavelength, to suppress background-light noise of the remaining bands. The TOF image sensor 121 may be an image sensor array including a charge-coupled device (CCD), a complementary metal-oxide semiconductor (CMOS), an avalanche diode (AD), a single photon avalanche diode (SPAD), and the like. An array size indicates the resolution of the depth camera, for example, 320*240. Generally, the TOF image sensor 121 may be further connected to a data processing unit and a read circuit (not illustrated in the figure) including one or more of devices such as a signal amplifier, a time-to-digital converter (TDC), and an analog-to-digital converter (ADC). Since the scenarios of the imaging module at different distances are concentric spheres of different diameters rather than parallel planes, an error may occur in actual use, and this error can be corrected by the data processing unit.

The TOF image sensor includes at least one pixel. Compared with a conventional image sensor only used for taking photos, each pixel herein includes more than two taps configured to store and read or output a charge signal generated by an incident photon under the control of a corresponding electrode. For example, three taps, in a single frame period (or a single exposure time), are switched in a specific sequence to capture corresponding charges in a certain order. In addition, the control and processing device further provides demodulated signals (captured signals) of taps in pixels of the TOF image sensor. Under the control of the demodulated signals, the taps capture the electrical signals (charges) generated by the reflected beam reflected by the target object.

The control and processing device is respectively connected to the light emitting module and the imaging module. When controlling the light emitting module to emit the beam, the control and processing device triggers the imaging module to be turned on to capture a part of the reflected beam corresponding to the emitted beam that is reflected by the target object, and convert the part of the reflected beam into an electrical signal. Further, a distance between the target object and the measuring device is measured by measuring a phase difference Δφ between an emitted signal of the emission module and a received signal of the imaging module. The relationship between the phase difference Δφ and the distance d is:

d=(c*Δφ)/4πf₁,

where c is a speed of light and f₁ is a modulation frequency.

In some embodiments, when the light source emits a continuous sine-wave modulated beam, the expression is:

(t)=a*(1+sin(2πf₂t)),

where the modulation frequency is f₂, the amplitude is a, the period T is 1/f₂, and the wavelength λ is c/f₂.

A reflected signal obtained after a delay Δφ of the signal is set to r(t). The signal amplitude is attenuated to A after propagation, and an offset caused by the ambient light is B, then the expression of the reflected signal is:

(t)=A*(1+sin(2πf₂t−Δφ))+B

The phase difference Δφ is calculated. In an embodiment of this application, measurement and calculation are performed by sampling received charges at four phase measuring points equidistant from each other (which are generally 0°, 90°, 180°, and 270°) within a valid integration time. That is, in four consecutive frames (within four exposure times), charges are respectively sampled by using four points having phase differences of 0°, 90°, 180°, and 270° with respect to the emitted light as starting points. Time points t0=0, t1=T/4, t2=T/2, and t3=3T/2 corresponding to the four sampling points 0°, 90°, 180°, and 270° are substituted into the equation r(t), and Δφ=arctan I/Q can be obtained by solving the equation, where I and Q are differences between values of the two non-adjacent charge samplings respectively. An ambient light bias, the maximal noise interference source in the process of depth measurement, may be eliminated by using the differences. Moreover, a larger I and a larger Q indicate higher accuracy of the phase difference measurement. In actual depth measurement, in order to improve the measurement accuracy, a plurality of images usually need to be captured for multiple measurements. Finally, a depth value of each pixel is calculated by weighing average values or by using other methods, and then a complete depth map is obtained.

A phase difference Δφ may vary due to changes of a distance of the target object. However, the phase difference Δφ calculated based on the foregoing mono-frequency may range from 0 to 2π, which can be effectively used for performing calculation for the accurate measurement within a “wrapped” phase (that is, a wavelength) for the given feature. Once an actual distance exceeds a maximum measurement distance λ=c/2f2, the final calculated phase difference Δφ may begin to repeat, for example, Δφ=Δφ+2π. Therefore, a plurality of measurement distances are provided for each mono-frequency measurement, and each distance is separated by the wrapped phase, that is:

dₘₑₐₛᵤᵣₑₘₑₙₜ=c(n+Δφ/2π)/2f₂,

where n is a wrapping number. A plurality of distances measured based on the mono-frequencies are referred to as fuzzy distances. According to the formula d=(c*Δφ)/4πf₁, the modulation frequency may affect the measurement distance. Under specific circumstances, the measurement distance may be extended by reducing the signal modulation frequency (that is, increase the wavelength). However, the measurement accuracy may decrease due to the reduced modulation frequency. To satisfy the measurement distance while ensuring measurement accuracy, a multi-frequency extension measurement technique is usually introduced into a TOF camera-based depth measuring device. The multi-frequency technique is described as follows.

The multi-frequency technique implements frequency mixing by adding one or more continuous modulated waves of different frequencies to the light emitting module. The continuous modulated wave of each frequency corresponds to a fuzzy distance. A distance jointly measured by the plurality of modulated waves is a real distance of a measured target object, and the corresponding frequency is the maximum common divisor of the plurality of modulated wave frequencies, referred to as a striking frequency. Apparently, the striking frequency is less than that of any modulated wave, to ensure the measurement distance extension without reducing the actual modulation frequency. It should be understood that, range aliasing can be eliminated on the phase difference data efficiently by using the multi-frequency ranging method. However, compared with single-frequency ranging, an exposure time of pixels needs to be increased in order to obtain a plurality of depth maps during multi-frequency ranging. As a result, the power consumption caused by the data transmission is increased, and the frame rate of the depth maps is reduced.

Therefore, in an embodiment of this application, the relative depth value of the target object is obtained by performing deep learning on the two-dimensional image that is captured by the imaging module and that is formed by the ambient light or a floodlight beam emitted by the light source. Further, the relative depth value is used for performing unwrapping the wrapped phase of the TOF depth values. Due to the high accuracy of the calculation based on the phase delay (phase difference), the relative depth value obtained by performing deep learning on the two-dimensional image may not need to be very accurate. Only a depth value closest to the relative depth value may be selected from the plurality of TOF depth values as a final depth value. In addition, since both the two-dimensional image and the TOF depth map are captured by the TOF image sensor from the same angle of view, pixels in the two-dimensional image are in a one-to-one correspondence with pixels in the TOF depth map. Therefore, the complex image matching process can be omitted, thus avoiding increase of the power consumption of the device.

In this way, the depth measuring device in an embodiment of this application performs deep learning on the two-dimensional image to obtain the relative depth value, and unwraps the wrapped phase of TOF depth values based on the relative depth value, so that precision, integrity, and a frame rate of a depth map is improved without increasing the costs of an existing depth measuring device.

In some embodiments, the control and processing device includes a depth calculating unit. The foregoing deep learning is performed by the depth calculating unit of the control and processing device. In some embodiments, the depth calculating unit may be FPGA/NPU/GPU or the like. The depth map may include a plurality of depth values. Each of the depth values corresponds to a single pixel of the TOF image sensor. In some embodiments, the depth calculating unit may output a relative depth value of the pixels in the two-dimensional image, so that the control and processing device may obtain a TOF depth value of each pixel by calculating the phase differences, and may select a depth value closest to the relative depth value obtained through deep learning from the plurality of TOF depth values corresponding to the phase differences as the actual depth value, to obtain the final depth map. In some embodiments, the control and processing device obtains the differences between the plurality of TOF depth values and the relative depth value, obtains absolute values of the differences, and selects a TOF depth value corresponding to a least absolute value as the actual depth value. In some embodiments, the control and processing device generates a depth map of the target object according to the actual depth values, or integrates or fuses the TOF depth map with the relative depth map obtained based on the relative depth value to generate a depth map of the target object.

In some embodiments, the depth calculating unit may obtain a depth model by designing the convolutional neural network structure and training a loss function of a known depth map. During the estimation of the relative depth value, a corresponding relative depth map can be obtained by directly inputting the two-dimensional image into the above convolutional neural network structure for deep learning. In some embodiments, the relative depth value may be indicated by a color value (or a gray value). As can be learned from the above description, the depth value calculated based on the phase delay (phase difference) has a high accuracy. Therefore, the accuracy requirement for a relative depth value of the target object estimated by using the two-dimensional image is not high, and thus the design requirement of the convolutional neural network structure is relatively simple. In this way, the relative depth value is used for performing unwrapping the wrapped phase of the TOF depth values in order to obtain the accurate actual distance of the target object without increasing the power or reducing the computational rate of the depth measuring device.

Referring to FIG. 2, an embodiment of this application further provides a TOF-based depth measuring method. FIG. 2 is a flowchart of the TOF-based depth measuring method. The measuring method includes the following steps.

S20: controlling a light emitting module to emit a modulated beam to a target object;

S21: controlling an imaging module to: capture a reflected beam corresponding to the emitted beam and reflected by the target object, generate a corresponding electrical signal based on the reflected beam, and obtain a two-dimensional image of the target object; and

S22: using a control and processing device to: receive the electrical signal generated by the imaging module and the two-dimensional image from the imaging module, perform calculation on the electrical signal to obtain one or more TOF depth values of the target object, simultaneously perform deep learning by using the two-dimensional image to obtain a relative depth value of the target object, and determine an actual depth value from the one or more TOF depth values based on the obtained relative depth value.

In step S22, the control and processing device includes a depth calculating unit. The depth calculating unit performs deep learning on the two-dimensional image by designing a convolutional neural network structure to obtain the relative depth value of the target object.

In step S22, the control and processing device obtains differences between the plurality of TOF depth values and the relative depth value, obtains absolute values of the differences, and selects a TOF depth value corresponding to a least absolute value as the actual depth value; or performs TOF depth value unwrapping based on the continuity of the relative depth value obtained through the deep learning, to determine the actual depth value from the one or more TOF depth values.

In some embodiments, the method further includes:

generating a depth map of the target object based on the actual depth value; or

fusing/integrating the TOF depth map with the relative depth map obtained based on the relative depth values to generate a depth map of the target object.

In some embodiments, the light emitting module is configured to emit, under the control of the control and processing device and at one or more modulation frequencies, a beam of which an amplitude is temporally modulated by a CW, the imaging module is configured to capture at least a part of the reflected beam and generate a corresponding electrical signal; and the control and processing device is configured to calculate a phase difference based on the electrical signal, calculate a time of flight from the beam being emitted to the reflected beam being captured based on the phase difference, and calculate TOF depth values of pixels based on the time of flight.

The TOF-based depth measuring method in an embodiment of this application is performed by the TOF-based depth measuring device in the foregoing embodiment. In an embodiment of implementation, references may be made to the description of the solution in the embodiment of the TOF-based depth measuring device, and details are not repeated herein.

In the embodiments of this application, by performing deep learning on the two-dimensional image to obtain the relative depth value, and unwrapping the wrapped phase of TOF depth value based on the relative depth value, precision, integrity, and a frame rate of a depth map is improved without increasing the costs of an existing depth measuring device.

All or some of the processes of the methods in the embodiments of this application may be implemented by a computer program instructing relevant hardware. The computer program may be stored in a non-transitory computer-readable storage medium. During execution of the computer program by the processor, steps of the foregoing method embodiments may be implemented. The computer program includes computer program code. The computer program code may be in source code form, object code form, executable file, or some intermediate forms, or the like. The computer-readable medium may include any entity or apparatus that is capable of carrying the computer program code, a recording medium, a USB flash drive, a removable hard disk, a magnetic disk, an optical disc, a computer memory, a read-only memory (ROM), a random access memory (RAM), an electric carrier signal, a telecommunication signal, a software distribution medium, and the like. The content contained in the non-transitory computer-readable medium may be appropriately increased or decreased according to the requirements of the legislation and patent practice in jurisdictions. For example, in some jurisdictions, according to the legislation and patent practice, the computer-readable medium does not include an electric carrier signal and a telecommunication signal.

Another embodiment of this application further provides electronic equipment. The electronic equipment may be a desktop device, a desktop-mounted device, a portable device, a wearable device, an in-vehicle device, a robot, or the like. For example, the electronic equipment may be a notebook computer or other electronic devices, which allows gesture recognition or biometric recognition. In other examples, the electronic equipment may be a headset device, configured to mark objects or hazards in a user's surrounding environment to ensure safety. For example, a virtual reality system that hinders the user's vision of the environment can detect objects or hazards in the surrounding environment to provide the user with warnings about nearby objects or obstacles.

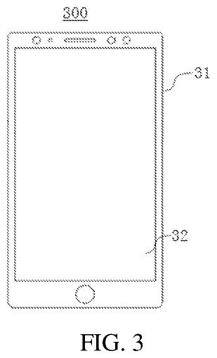

In some other examples, the electronic equipment may be a mixed reality system that mixes virtual information and images with the user's surrounding environment. This system can detect objects or people in the user's surrounding environment to integrate the virtual information with the physical environment and objects. In other examples, the electronic equipment may also be a device applied to the unmanned driving and other fields. Referring to FIG. 3, using a mobile phone as an example, the electronic equipment 300 includes a housing 31, a screen 32, and the TOF-based depth measuring device in the foregoing embodiment. The light emitting module 11 and the imaging module 12 of the TOF-based depth measuring device are disposed on the same side of the electronic equipment 300, to emit a beam to a target object, receive a floodlight beam reflected by the target object, and generate an electrical signal based on the reflected beam.

The foregoing contents are detailed descriptions of this application in conjunction with embodiments. The implementation of this application is not limited to these descriptions. A person of ordinary skill in the art, may make various replacements or variations on the described implementations without departing from the concept of this application, and the replacements or variations fall within the protection scope of this application. In the descriptions of this specification, descriptions using reference terms “an embodiment,” “some embodiments,” “an exemplary embodiment,” “an example,” “a specific example,” or “some examples” mean that specific characteristics, structures, materials, or features described with reference to the embodiment or example are included in at least one embodiment or example of this application.

In embodiments of this application, schematic descriptions of the foregoing terms are not necessarily directed at the same embodiment or example. Besides, the specific features, the structures, the materials or the characteristics that are described may be combined in any manners in any one or more embodiments or examples. In addition, a person skilled in the art may integrate or combine different embodiments or examples described in the specification and features of the different embodiments or examples as long as they are not contradictory to each other. Although the embodiments of this application and advantages thereof have been described in detail, various changes, substitutions, and alterations can be made herein without departing from the scope defined by the appended claims.

In addition, the scope of this application is not limited to the specific embodiments of the processes, machines, manufacturing, material composition, means, methods, and steps described in the specification. A person of ordinary skill in the art can easily understand and use the above disclosures, processes, machines, manufacturing, material composition, means, methods, and steps that currently exist or will be developed later and that perform substantially the same functions as the corresponding embodiments described herein or obtain substantially the same results as the embodiments described herein. Therefore, the appended claims intend to include such processes, machines, manufacturing, material compositions, means, methods, or steps within the scope thereof.

What is claimed is:

1. A time of flight (TOF)-based depth measuring device, comprising:
a light emitter configured to emit a beam to a target object;
a light sensor configured to capture a reflected beam reflected by the target object, generate an electrical signal corresponding to the reflected beam, and obtain a two-dimensional image of the target object; and
a processor connected to the light emitter and the light sensor, and configured to:
control the light emitter to emit a modulated beam to a target space,
turn on the light sensor to receive the electrical signal generated by the light sensor and the two-dimensional image,
perform calculation on the electrical signal to obtain one or more TOF depth values of the target object,
obtain a relative depth value of the target object according to the two-dimensional image, and
determine an actual depth value from the one or more TOF depth values based on the relative depth value.

2. The device according to claim 1, wherein
the light emitter is configured to emit, under the control of the processor and at one or more modulation frequencies, the modulated beam of which an amplitude is modulated by a continuous wave;
the light sensor is configured to capture at least a part of the reflected beam and generate the electrical signal; and
the processor is configured to calculate a phase difference based on the electrical signal, calculate a time of flight from the beam being emitted at the light emitter to the reflected beam being captured by the light sensor based on the phase difference, and calculate the one or more TOF depth values based on the time of flight.

3. The device according to claim 1, wherein the processor further comprises a convolutional neural network structure configured to perform deep learning on the two-dimensional image to obtain the relative depth value of the target object.

4. The device according to claim 1, wherein turning on the light sensor is synchronized with the emitting the modulated beam to the target space.

5. The device according to claim 3, wherein the deep learning is performed on the two-dimensional image to obtain the relative depth value of the target object simultaneously while performing the calculation on the electrical signal.

6. The device according to claim 1, wherein the light sensor is a first light sensor and the two-dimensional image of the target object is a first two-dimensional image of the target object, wherein the device further comprises a second light sensor configured to obtain a second two-dimensional image of the target object.

7. The device according to claim 6, wherein the relative depth value of the target object is obtained according to the first two-dimensional image and the second two-dimensional image.

8. A time of flight (TOF)-based depth measuring method, comprising:
emitting, by a light emitter, a modulated beam to a target object;
capturing, by a light sensor, a reflected beam reflected by the target object, generating an electrical signal based on the reflected beam, and obtaining a two-dimensional image of the target object; and
receiving, by a processor, the electrical signal generated by the light sensor and the two-dimensional image from the light sensor, performing calculation on the electrical signal to obtain one or more TOF depth values of the target object, obtaining a relative depth value of the target object according to the two-dimensional image, and determining an actual depth value from the one or more TOF depth values based on the obtained relative depth value.

9. The method according to claim 8, further comprising:
emitting, by the light emitter, under the control of the processor and at one or more modulation frequencies, a modulated beam of which an amplitude is modulated by a continuous wave;
capturing, by the light sensor, at least a part of the reflected beam reflected by the target object, and generating the electrical signal; and
calculating, by the processor, a phase difference based on the electrical signal, calculating a time of flight from the beam being emitted at the light emitter to the reflected beam being captured by the light sensor based on the phase difference, and calculating the one or more TOF depth values based on the time of flight.

10. The method according to claim 8, wherein
the processor comprises a convolutional neural network structure configured to perform deep learning on the two-dimensional image to obtain the relative depth value of the target object.

11. The method according to claim 8, further comprising:
obtaining, by the processor, differences between the one or more TOF depth values and the relative depth value, obtaining absolute values of the differences, and selecting a TOF depth value corresponding to a least absolute value as the actual depth value; or
unwrapping, by the processor, the one or more TOF depth values based on continuity of the relative depth value, and determining the actual depth value from the one or more TOF depth values.

12. The method according to claim 8, further comprising: generating, by the processor, a TOF depth map of the target object based on the one or more TOF depth values, and generating a relative depth map of the target object based on relative depth values.

13. The method according to claim 12, further comprising:
generating a depth map of the target object based on actual depth values; or
integrating the TOF depth map with the relative depth map to generate a depth map of the target object.

14. The method according to claim 8, wherein obtaining the relative depth value of the target object comprises performing deep learning on the two-dimensional image to obtain the relative depth value simultaneously while performing the calculation on the electrical signal.

15. Electronic equipment, comprising: a housing, a screen, and a time of flight (TOF)-based depth measuring device, wherein:
the TOF-based depth measuring device comprises a processor, a light emitter, and a light sensor, and the light emitter and the light sensor are disposed on a same side of the electronic equipment;
the light emitter, configured to emit a beam to a target object;
the light sensor, configured to capture a reflected beam reflected by the target object, generate an electrical signal corresponding to the reflected beam, and obtain a two-dimensional image of the target object; and
the processor connected to the light emitter and the light sensor, and configured to: control the light emitter to emit a modulated beam to a target space, turn on the light sensor to receive the electrical signal generated by the light sensor and the two-dimensional image, perform calculation on the electrical signal to obtain one or more TOF depth values of the target object, obtain a relative depth value of the target object according to the two-dimensional image, and determine an actual depth value from the one or more TOF depth values based on the relative depth value.

16. The electronic equipment according to claim 15, wherein the relative depth value of the target object is obtained by simultaneously performing deep learning on the two-dimensional image, while performing the calculation on the electrical signal.

17. The electronic equipment according to claim 15, wherein turning on the light sensor is synchronized with emitting the modulated beam to the target space.

18. The electronic equipment according to claim 15, wherein the light sensor is a first light sensor and the two-dimensional image of the target object is a first two-dimensional image of the target object, wherein the device further comprises a second light sensor configured to obtain a second two-dimensional image of the target object.

19. The electronic equipment according to claim 15, wherein the relative depth value of the target object is obtained according to the first two-dimensional image and the second two-dimensional image.

20. The electronic equipment according to claim 15, wherein
the light emitter is configured to emit, under the control of the processor and at one or more modulation frequencies, the modulated beam of which an amplitude is modulated by a continuous wave;
the light sensor is configured to capture at least a part of the reflected beam and generate the electrical signal; and
the processor is configured to calculate a phase difference based on the electrical signal, calculate a time of flight from the beam being emitted at the light emitter to the reflected beam being captured by the light sensor based on the phase difference, and calculate the one or more TOF depth values based on the time of flight.
